(19) United States
(12) Patent Application Publication
(10) Pub. No.: US 2007/0126415 A1
(43) Pub. Date: Jun. 7, 2007

(54) MECHANICAL QUANTITY DETECTING ELEMENT AND MECHANICAL QUANTITY DETECTING DEVICE

(75) Inventor: Hidemi SENDA, Toyota-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/548,043

(22) Filed: Oct. 10, 2006

(30) Foreign Application Priority Data
Oct. 14, 2005 (JP) 2005-300568

(51) Int. Cl. G01P 3/42

(52) U.S. Cl. 324/160

(57) ABSTRACT

A mechanical quantity detecting element includes a main frame displaceably supported with respect to a substrate in an X axis direction parallel to a surface of the substrate, a transducer displaceably supported with respect to the main frame in a Y axis direction perpendicular to the X axis direction and parallel to the surface of the substrate, and a plurality of drive electrode portions which are provided on the main frame and drive the main frame in the X axis direction. The main frame includes a terminal portion where an end of the main frame extends in the Y axis direction, and at least one of the plurality of drive electrode portions is arranged on each side in the X axis direction of the terminal portion.

### INCORPORATION BY REFERENCE

The disclosure of Japanese Patent Application No. 2005-300568 filed on Oct. 14, 2005 including the specification, drawings and abstract is incorporated herein by reference in its entirety.

### BACKGROUND OF THE INVENTION

1. Field of the Invention

The invention relates to a mechanical quantity detecting element for detecting a mechanical quantity such as angular velocity by displacement of a transducer provided floating on a substrate, as well as a mechanical quantity detecting device provided with that element.

2. Description of the Related Art

Japanese Patent Nos. 3525862 and 3512004, for example, describe sensor devices which are provided with a main frame displaceably supported in an X axis direction with respect to a substrate and detect an angular velocity around a Z axis by detecting the magnitude of vibration in a Y axis direction of a transducer displaceably supported in the Y axis direction with respect to the main frame.

FIG. 6 is a plan view schematically showing a semiconductor which is used as an angular velocity detecting element that is housed in the sensor device described in Japanese Patent No. 3525862. In this angular velocity detecting element, drive electrode portions 51-1 to 51-4 for driving main frames 30-1 and 30-2 in an X axis direction with respect to a substrate 10 are arranged opposite in the X axis in positions on the outside in the X axis direction of terminal end portions 32-1 to 32-4 of the main frames 30-1 and 30-2. The main frames 30-1 and 30-2 are vibrated in the X axis direction with respect to the substrate 10 by inputting a voltage having a predetermined AC component to the left side drive electrode portions 51-1 and 51-3 in FIG. 6 and a voltage in which the AC component is reversed with respect to the predetermined AC component to right side drive electrode portions 51-2 and 51-4 in FIG. 6. When an angular velocity is applied around the Z axis in this state, a transducer 20 starts to vibrate in the Y axis direction with an amplitude proportionate to that angular velocity by Coriolis force.

FIG. 7 is a plan view schematically showing a semiconductor which is used as an angular velocity detecting element that is housed in the sensor device described in Japanese Patent No. 3512004. In this angular velocity detecting element, drive electrode portions 51-1 and 51-2 are arranged in positions on the outside in the X axis direction of protruding portions 36a and 36b of end portions, respectively, that are on the outside in the X axis direction of main frames 30-1 and 30-2, and drive electrode portions 51-3 and 51-4 are arranged in positions on the inside in the X axis direction of protruding portions 36c and 36d of end portions, respectively, on the outside in the X axis direction of main frames 30-3 and 30-4. The main frames 30-1 to 30-4 are vibrated in the X axis direction with respect to the substrate 10 by inputting a voltage having a predetermined AC component to the left side drive electrode portions 51-1 and 51-2 in FIG. 7 and a voltage in which the AC component is reversed with respect to the predetermined AC component to right side drive electrode portions 51-3 and 51-4 in FIG. 7. When an angular velocity is applied around the Z axis in this state, transducers 20-1 and 20-2 start to vibrate in the Y axis direction with an amplitude proportionate to that angular velocity by Coriolis force.

When voltage that includes a bias voltage is input to a drive electrode portions arranged like the sensor devices described above, however, a bias component of a driving force proportionate to the square of that input voltage is constantly applied to the main frame. As a result, the vibration is unstable due to deformation or the like of the main frame which makes it difficult to accurately detect displacement of the transducer.

For example, with the sensor device described in Japanese Patent No. 3525862, bias components in which the direction of force is opposite from one another are constantly applied to the ends of the main frames 30-1 and 30-2, which makes the main frames 30-1 and 30-2 prone to deformation. With the sensor device described in Japanese Patent No. 3512004, on the other hand, the bias components cause the main frames 30-1 and 30-2 to vibrate around a position offset to the left with respect to the protruding portions 36a to 36d so the vibration tends to be unstable.

### SUMMARY OF THE INVENTION

The object of the present invention is to provide a mechanical quantity detecting device provided with that mechanical quantity detecting element, which improves the detection accuracy of displacement of a transducer.

A first aspect of the invention relates to a mechanical quantity detecting element. This mechanical quantity detecting element includes a substrate, a frame which is displaceably supported in a first direction that is parallel with a surface of the substrate, a transducer which is displaceably supported, with respect to the frame, in a second direction that is perpendicular to the first direction and parallel with the surface of the substrate, and a plurality of drive electrode portions which are provided on the frame and drive the frame in the first direction. The frame is provided with a terminal portion where an end of the frame extends in the second direction. At least one of the plurality of drive electrode portions is arranged on each side of the terminal end portion in the first direction.

According to the mechanical quantity detecting element described above, when a drive signal having a predetermined phase which includes a bias voltage is input into the at least one of the plurality of drive electrode portions provided on one side in the first direction and a drive signal having a phase that is reversed with respect to that predetermined phase, which includes the bias voltage, is input into the at least one of the plurality of drive electrode portions provided on the other side in the first direction, the direction of the force of the bias component of the driving force from the drive signal input to the at least one of the plurality of drive electrode portions on one side in the first direction is opposite the direction of the force of the bias component of the driving force from the drive signal input to the at least one of the plurality of drive electrode portions on the other side in the first direction so they cancel each other out. As a result, deformation or the like of the frame is suppressed, thereby enabling the vibration to be stabilized which improves the detection accuracy of displacement of the transducer.

A second aspect of the invention relates to a mechanical quantity detecting device provided with the mechanical quantity detecting element described above. This mechanical quantity detecting device detects the displacement in the second direction of the transducer while the frame is vibrated in the first direction with respect to the substrate in response to a drive signal having a predetermined phase being input to the at least one of the plurality of drive electrode portions provided on one side in the first direction of the terminal portion, and a drive signal in which the phase is reversed with respect to the predetermined phase being input to the at least one of the plurality of drive electrode portions provided on the other side in the first direction of the terminal portion.

The invention thus improves the detection accuracy of the displacement of a transducer.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a plan view schematically showing a semiconductor which is used as an angular velocity detecting element according to a first example embodiment of the invention;

FIG. 2 is a block diagram of an electrical circuit device for detecting angular velocity using the angular velocity detecting element according to the first example embodiment;

FIG. 3 is a plan view schematically showing a semiconductor which is used as an angular velocity detecting element according to a second example embodiment of the invention;

FIG. 4 is a block diagram of an electrical circuit device for detecting angular velocity using the angular velocity detecting element according to the second example embodiment;

FIG. 5 is a plan view schematically showing the angular velocity detecting element when a drive electrode portion for increasing a driving force has been added in the second example embodiment;

FIG. 6 is a plan view schematically showing a semiconductor which is used as an angular velocity detecting element that is housed in a sensor device described in Japanese Patent No. 3525862; and

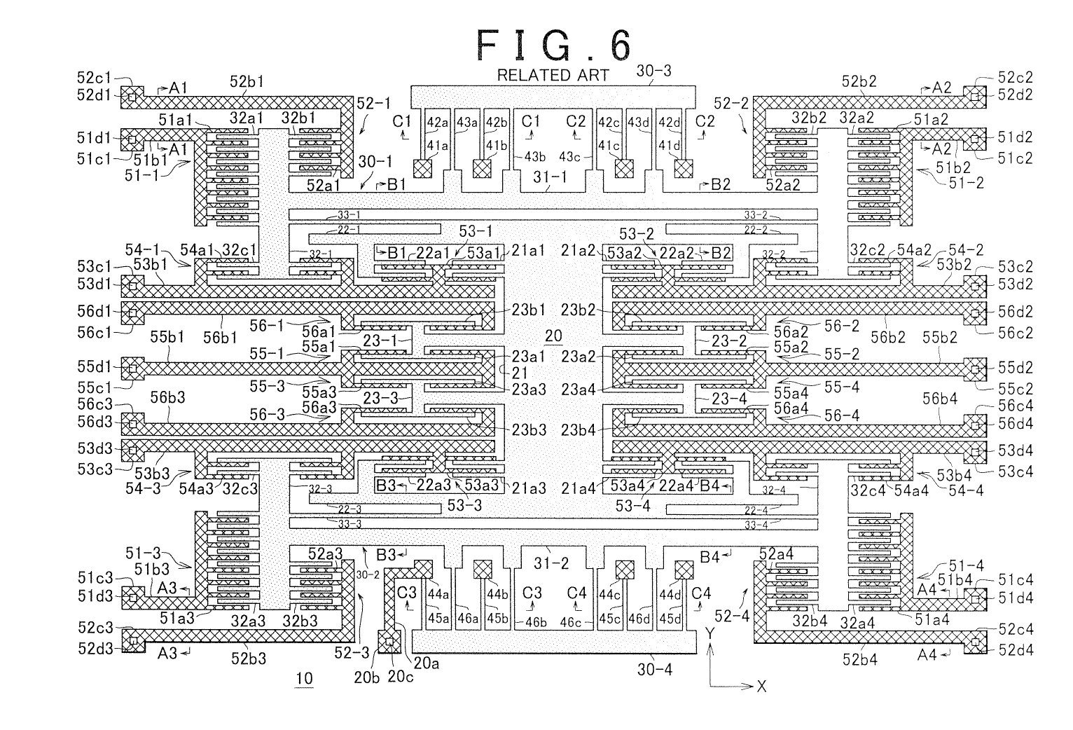

FIG. 7 is a plan view schematically showing a semiconductor which is used as an angular velocity detecting element that is housed in a sensor device described in Japanese Patent No. 3512004.

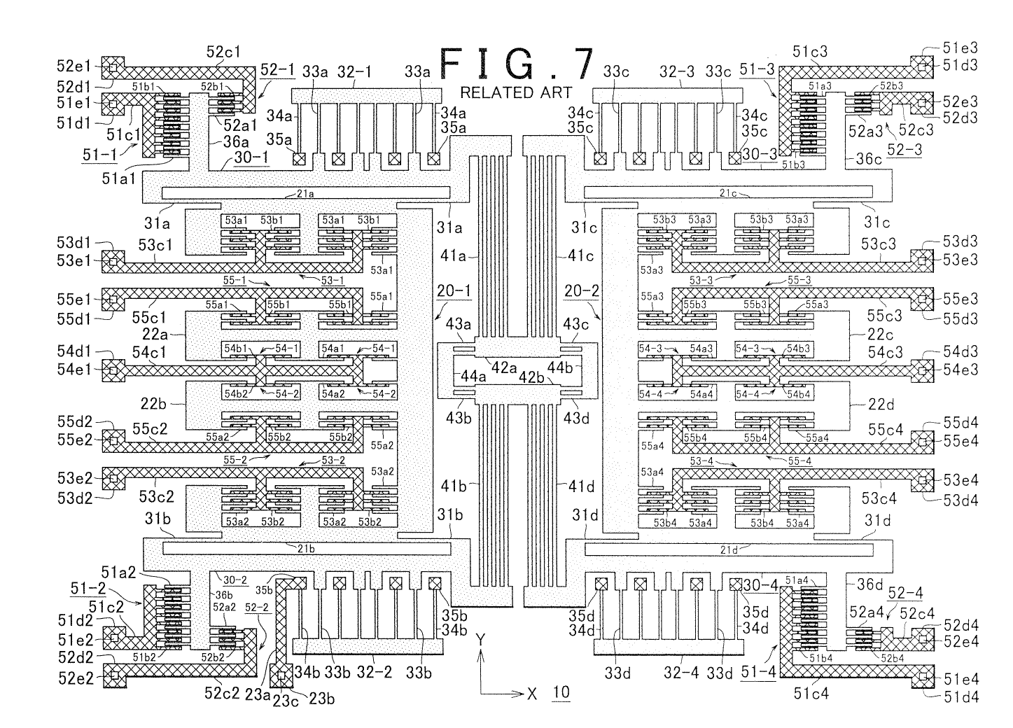

### DETAILED DESCRIPTION OF THE PREFERRED EMBODIMENTS

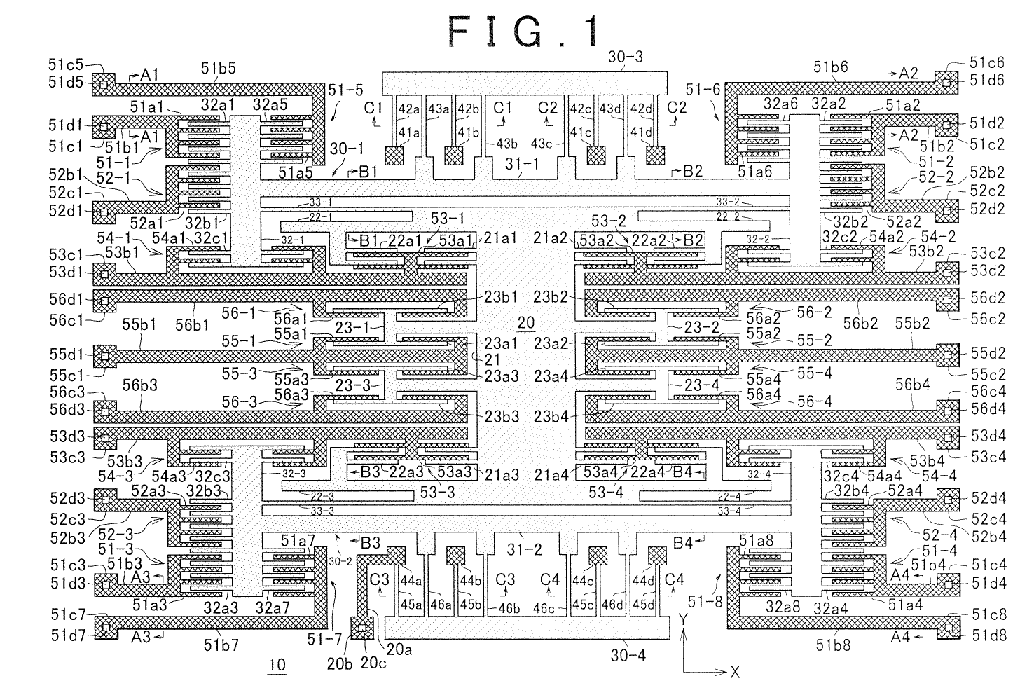

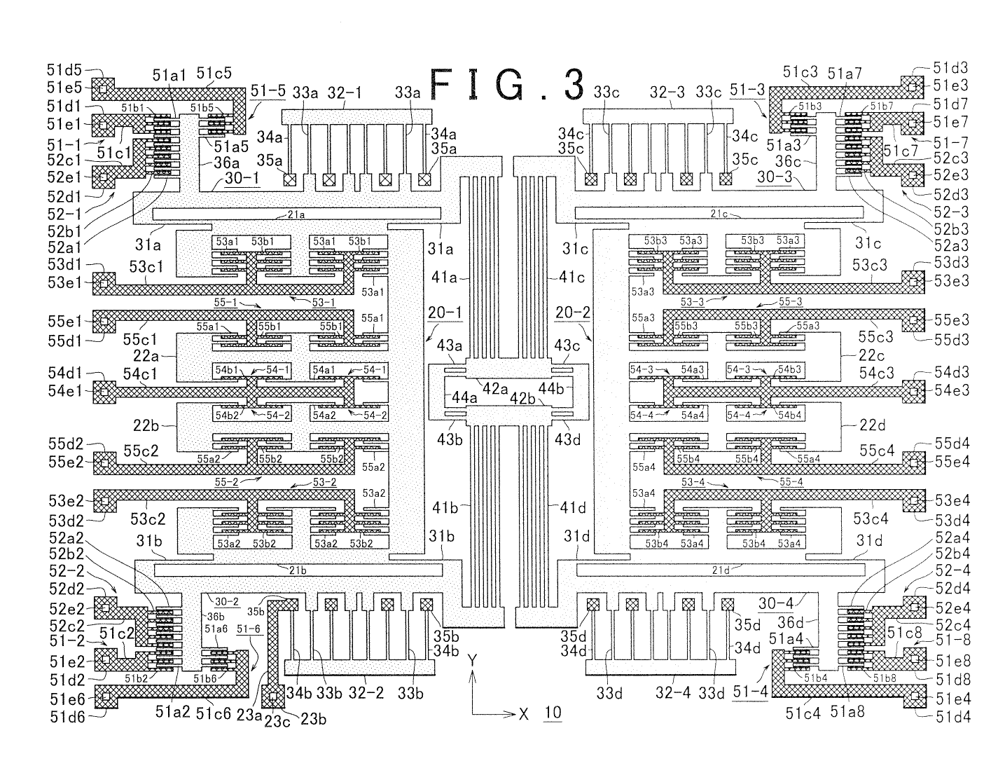

In the following description and the accompanying drawings, the present invention will be described in more detail in terms of exemplary embodiments. FIG. 1 is a plan view schematically showing a semiconductor which is used as an angular velocity detecting element according to a first example embodiment of the invention, and FIG. 3 is a plan view schematically showing a semiconductor which is used as an angular velocity detecting element according to a second example embodiment of the invention. To make these elements, a SOI (Silicon On Insulator) substrate in which a layer of single-crystal silicon (having a film thickness of, for example, 40 μm) has been applied to an upper surface of a single-crystal silicon layer via a silicon dioxide film (having a film thickness of, for example, 4.5 μm) is first prepared. Then an impurity such as phosphorous or boron is doped onto the single-crystal silicon layer to reduce the resistivity of the upper surface portion of the single-crystal silicon layer, i.e., to create a conducting sleeve layer. The bottom single-crystal silicon layer then serves as a substrate 10. Various functioning components are then formed on the substrate 10 by removing the silicon dioxide film (i.e., the insulating layer) which is the intermediate layer and the conducting sleeve layer which is the top layer by reactive etching or the like, and removing only the silicon dioxide film (i.e., the insulating layer) while leaving the conducting sleeve layer, i.e., the top layer, in tact by etching using an aqueous solution of hydrofluoric acid or the like.

In FIGS. 1 and 3, the portions where both the insulating layer (i.e., the intermediate layer) and the conducting sleeve layer (i.e., the top layer) have been removed are shown in white, and the portions where only the insulating layer (i.e., the intermediate layer) has been removed are shown with a dotted pattern. As will be described later, the dotted portions will be described as portions that are floating on the substrate 10. Also, portions where both the insulating layer (i.e., the intermediate layer) and the conducting sleeve layer (i.e., the top layer) have been left in tact on the substrate 10 are shown with a mesh pattern. Hereinafter, the portions indicated with mesh will be described as portions that are fixed to the substrate 10.

FIG. 1 is a view of an example in which the invention is applied to a mechanical quantity detecting element that is described in U.S. Pat. No. 6,568,267, and FIG. 3 is a view of an example in which the invention is applied to a mechanical quantity detecting element that is described in Japanese Patent No. 3512004. Therefore, in the following description portions of the invention which are similar to the structure described in U.S. Pat. No. 6,568,267 will be denoted by like reference numerals and descriptions thereof will be simplified or omitted.

### First Example Embodiment

In FIG. 1, the transducer 20 vibrates in the Y axis direction from the angular velocity around the Z axis that is orthogonal to both the X and Y axes, with an amplitude proportionate to the magnitude of that angular velocity, while vibrating in the X axis direction. The transducer 20 is shaped generally like the letter “H” and includes a square mass portion 21, one side of which extends in the X axis direction and the other side of which extends in the Y axis direction, which is provided in a center portion and has an appropriate mass, and four arm portions 22-1 to 22-4 that extend in the X axis direction from diagonal positions of the mass portion 21.

The main frames 30-1 and 30-2 make the transducer 20 vibrate in the X axis direction. Each of these main frames 30-1 and 30-2 is shaped substantially like the letter “I”, including wide long portions 31-1 and 31-2, each of which extends in the X axis direction in a position to the outside in the Y axis direction of the arm portions 22-1 to 22-4 of the transducer 20, and wide terminal portions 32-1 to 32-4, each of which extends in the Y axis direction on both sides at each end of both long portions 31′-1 and 31-2. Sub-frames 30-3 and 30-4 which are also wide are formed extending in the X axis direction on the outside in the Y axis direction of the long portions 31-1 and 31-2.

The main frames 30-1 and 30-2 are connected to the transducer 20 by beams 33-1 to 33-4 which are also formed extending in the X axis direction within a horizontal plane that is separated from the top surface of the substrate 10 by a predetermined distance. One end of each beam 33-1 to 33-4 is connected near the base of an arm portion 22-1 to 22-4 of the transducer 20, and the other end of each beam 33-1 to 33-4 is connected to a terminal portion 32-1 to 32-4 of the main frames 30-1 and 30-2. Further, the width in the Y axis direction of the beams 33-1 to 33-4 is smaller than the width in the Y axis direction of the arm portions 22-1 to 22-4 of the transducer 20 and the long portions 31-1 and 31-2 and the terminal portions 32-1 to 32-4 of the main frames 30-1 and 30-2. Therefore, vibration in the Y axis direction is less likely to be transmitted from the main frames 30-1 and 30-2 to the transducer 20 while vibration in the X axis direction is effectively transmitted from the main frames 30-1 and 30-2 to the transducer 20, and the transducer 20 is more easily displaced in the Y axis direction than it is in the X axis direction with respect to the main frames 30-1 and 30-2. That is, the beams 33-1 to 33-4 serve to displaceably support the transducer 20 in the Y axis direction with respect to the substrate 10, the main frames 30-1 and 30-2, and the sub-frames 30-3 and 30-4.

The main frame 30-1 is displaceably supported with respect to the substrate 10 via anchors 41a to 41d, beams 42a to 42d, the sub-frame 30-3, and beams 43a to 43d. The anchors 41a to 41d are fixed to top surface of the substrate 10 in positions to the outside of the long portion 31-1 of the main frame 30-1. One end of each of the beams 42a to 42d is connected to a corresponding one of the anchors 41a to 41d. These beams 42a to 42d extend from the anchors 41a to 41d toward the outside in the Y axis direction. The other end of each beam 42a to 42d is connected to the inside end of the frame 30-3. One end of each of the beams 43a to 43d that extend toward the inside in the Y axis direction of the frame 30-3 is connected to the sub-frame 30-3. The other end of each beam 43a to 43d is connected to the outside end of the long portion 31-1 of the main frame 30-1. The beams 42a to 42d and 43a to 43d are provided floating a predetermined distance above the substrate 10, similar to the main frames 30-1 and 30-2 and the sub-frames 30-3 and 30-4, and are narrow like the beams 33-1 to 33-4.

The main frame 30-2 is displaceably supported with respect to the substrate 10 via anchors 44a to 44d, beams 45a to 45d, the sub-frame 30-4, and beams 46a to 46d. These anchors 44a to 44d, beams 45a to 45d, the sub-frame 30-4, and beams 46a to 46d are of the same structure as and symmetrical to, with respect to the center line in the Y axis direction, the anchors 41a to 41d, beams 42a to 42d, the sub-frame 30-3, and beams 43a to 43d. This structure enables the main frames 30-1 and 30-2 to be supported in a manner easily displaceable in the X axis direction with respect to the substrate 10 but not easily displaceable in the Y axis direction with respect to the substrate 10. That is, the beams 42a to 42d, 43a to 43d, 45a to 45d, and 46a to 46d serve to displaceably support the main frames 30-1 and 30-2, the sub-frames 30-3 and 30-4, and the transducer 20 in the X axis direction with respect to the substrate 10.

Also, on the substrate 10 are provided drive electrode portions 51-1 to 51-8 for driving the main frames 30-1 and 30-2 in the X axis direction with respect to the substrate 10, drive monitor electrode portions 52-1 to 52-4 for monitoring the driving of the main frames 30-1 and 30-2 in the X axis direction with respect to the substrate 10, detection electrode portions 53-1 to 53-4 for detecting vibration of the transducer 20 in the Y axis direction with respect to the substrate 10, correction electrode portions 54-1 to 54-4 for canceling out effects from oblique vibration (a vibration component in the Y axis direction) on the main frames 30-1 and 30-2 that are generated when the main frames 30-1 and 30-2 are driven, adjustment electrode portions 55-1 to 55-4 for adjusting the resonance frequency of the transducer 20, and adjustment electrode portions 56-1 to 56-4 for canceling out vibration of the transducer 20 in the Y axis direction.

The drive electrode portions 51-1 to 51-8 each include a plurality of pectinate (i.e., comblike) fixed electrode fingers 51a1 to 51a8 on both sides in the X axis direction of the terminal portions 32-1 to 32-4 of the main frames 30-1 and 30-2. These fixed electrodes 51a1 to 51a8 extend in the X axis direction toward the terminal portions 32-1 to 32-4 and are connected to pad portions 51c1 to 51c8 via wiring portions 51b1 to 51b8 that extend to the outside in the X axis direction. These fixed electrode fingers 51a1 to 51a8, the wiring portions 51b1 to 51b8, and the pad portions 51c1 to 51c8 are all fixed to the top surface of the substrate 10. Electrode pads 51d1 to 51d8 formed of a conductive metal (such as aluminum) are provided on the top surface of the pad portions 51c1 to 51c8.

The terminal portions 32-1 to 32-4 each include a plurality of pectinate (i.e., comblike) movable electrode fingers 32a1 to 32a8 that extend toward both sides in the X axis direction opposite the fixed electrode fingers 51a1 to 51a8. The movable electrode fingers 32a1 to 32a8 are integrally formed with the terminal portions 32-1 and 32-4 and provided floating a predetermined distance above the top surface of the substrate 10. These electrodes 32a1 to 32a8 fit in between adjacent fixed electrode fingers 51a1 to 51a8 which also extend in the X axis direction in an opposing manner.

The drive monitor electrode portions 52-1 to 52-4 each include a plurality of pectinate (i.e., comblike) fixed electrode fingers 52a1 to 52a4 on the outside in the X axis direction of the terminal portions 32-1 to 32-4 of the main frames 30-1 and 30-2. These fixed electrodes 52a1 to 52a4 extend in the X axis direction toward the terminal portions 32-1 to 32-4 and are connected to pad portions 52c1 to 52c4 via wiring portions 52b1 to 52b4 that extend to the outside in the X axis direction. These fixed electrode fingers 52a1 to 52a4, the wiring portions 52b1 to 52b4, and the pad portions 52c1 to 52c4 are all fixed to the top surface of the substrate 10. An electrode pad 52d1 to 52d4 formed of a conductive metal (such as aluminum) is provided on the top surface of each pad portion 52c1 to 52c4.

The terminal portions 32-1 to 32-4 each include a plurality of pectinate (i.e., comblike) movable electrode fingers 32b1 to 32b4 that extend toward the outside in the X axis direction opposite the fixed electrodes 52a1 to 52a4. The movable electrode fingers 32b1 to 32b4 are integrally formed with the terminal portions 32-1 and 32-4 and provided floating a predetermined distance above the top surface of the substrate 10. These movable electrode fingers 32b1 to 32b4 fit in between adjacent fixed electrode fingers 52a1 to 52a4 which also extend in the X axis direction in an opposing manner.

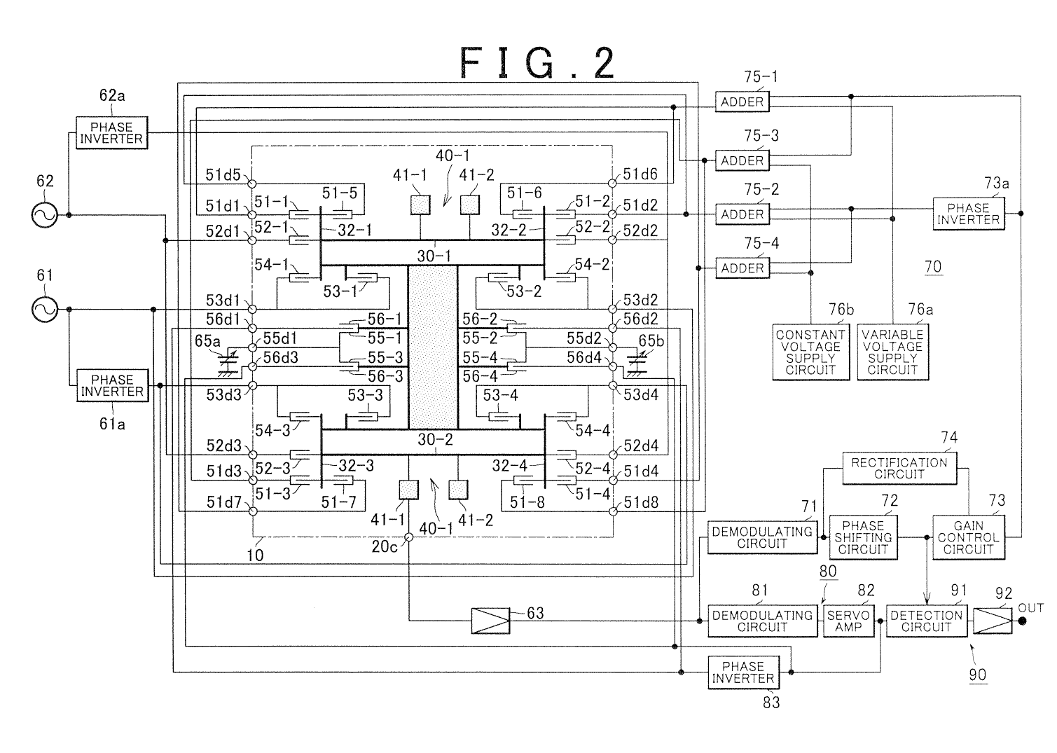

Next, an electrical circuit device for detecting angular velocity using the angular velocity detecting element having the foregoing structure will be described. FIG. 2 is a block diagram of this electrical circuit device.

A drive circuit 70 is connected to each electrode pad 51d1 to 51d8 of the drive electrode portion 51-1 to 51-8. This drive circuit 70 generates a drive signal based on a signal input from an electrode pad 20c via an amplifier 63 and then supplies that drive signal to each of the electrode pads 51d1 to 51d8.

Here, in order to simplify the description, a signal output by a gain control circuit 73 will be defined as VD sin(ωt), and a direct current voltage signal (i.e., a bias voltage signal) output by a variable voltage supply circuit 76a and a direct current voltage signal (i.e., a bias voltage signal) output by a constant voltage supply circuit 76b will both be defined as VB.

An adder 75-1 adds the signal VD sin(ωt) from the gain control circuit 73 to the direct current voltage signal VB from the variable voltage supply circuit 76a and supplies the sum voltage [VB+VD sin(ωt)] to the electrode pad 51d1 of the drive electrode portion 51-1 and the electrode pad 51d6 of the drive electrode portion 51-6. An adder 75-2 adds a signal −VD sin(ωt) from a phase inverter 73a to the direct current voltage signal VB from the variable voltage supply circuit 76a and supplies the sum voltage [VB−VD sin(ωt)] to the electrode pad 51d2 of the drive electrode portion 51-2 and the electrode pad 51d5 of the drive electrode portion 51-5. An adder 75-3 adds the signal VD sin(ωt) from the gain control circuit 73 to the direct current voltage signal VB from the constant voltage supply circuit 76b and supplies the sum voltage [VB+VD sin(ωt)] to the electrode pad 51d3 of the drive electrode portion 51-3 and the electrode pad 51d8 of the drive electrode portion 51-8. An adder 75-4 adds a signal −VD sin(ωt) from the phase inverter 73a to the direct current voltage signal VB from the constant voltage supply circuit 76b and supplies the sum voltage [VB−VD sin(ωt)] to the electrode pad 51d4 of the drive electrode portion 51-4 and the electrode pad 51d7 of the drive electrode portion 51-7.

When voltage V is applied between the pectinate fixed electrode fingers and the pectinate movable electrode fingers, a driving force (an attraction force) F shown in Expression 1 below is generated in the X axis direction, as is well known.

[Expression 1]
F=(εNhV²)/2g

Here, ε is a dielectric constant, g is a gap between the pectinate electrode fingers, N is the number of gaps, and h is the height (i.e., in the direction perpendicular to the paper on which FIG. 1 is drawn) of the pectinate electrode fingers. That is, the driving force is proportionate to the square of the applied voltage.

If the driving force from the drive electrode portions 51-1, 51-3, 51-6, and 51-8 to which the sum voltage [VB+VD sin(ωt)] is supplied by the adders 75-1 and 75-3 is designated F1 and the driving force from the drive electrode portions 51-2, 51-4, 51-5, and 51-7 to which the sum voltage [VB−VD sin(ωt)] is supplied by the adders 75-2 and 75-4 is designated F2, then F1 and F2 can be expressed as shown in Expressions 2 and 3 below.

[Expression 2]

$$\begin{matrix}F 1 = {α [ VB + VD sin ( ω t ) ]}^{2} \\ = α [ {VB}^{2} + 2 VB \times VD sin ( ω t ) + {VD}^{2} {sin}^{2} ( ω t ) ]\end{matrix}$$

[Expression 3]

$$\begin{matrix}F 2 = {α [ VB - VD sin ( ω t ) ]}^{2} \\ = α [ {VB}^{2} - 2 VB \times VD sin ( ω t ) + {VD}^{2} {sin}^{2} ( ω t ) ]\end{matrix}$$

The proportional constant is α. Therefore, the bias component FB1 of F1, the drive component FD1 of F1, the bias component FB2 of F2, and the drive component FD2 of F2 can be expressed as shown in the Expressions 4 to 7 below.

[Expression 4]
FB1=α[VB²+VD² sin²(ωt)]

[Expression 5]
FD1=α[2VB×VD sin(ωt)]

[Expression 6]
FB2=α[VB+VD² sin²(ωt)]=FB1

[Expression 7]
FD2=−α[2VB×VD sin(ωt)]=−FD1

The magnitude of force of the bias component FB1 of the driving force F1 from the drive electrode portion 51-1 on the upper left side in the drawing with respect to the terminal portion 32-1 is the same as that of the bias component FB2 of the driving force F2 from the drive electrode portion 51-5 on the upper right side in the drawing with respect to the terminal portion 32-1, but the directions of those forces are the opposite. As a result, they cancel each other out in the terminal portion 32-1. Also, the drive component FD1 of the driving force F1 from the drive electrode portion 51-1 is generated to the left in the X axis direction, and the drive component FD2 (=−FD 1) of the driving force F2 from the drive electrode 51-5 is generated to the right in the X axis direction. As a result, FD1−(−FD1)=2×FD1 is generated to the left in the X axis direction in the terminal portion 32-1. The same can also be said for the relationship between the driving force F1 from the drive electrode portion 51-6 on the upper left side in the drawing with respect to the terminal portion 32-2 and the driving force F2 from the drive electrode portion 51-2 on the upper right side in the drawing with respect to the terminal portion 32-2, the relationship between the driving force F1 from the drive electrode portion 51-3 on the upper left side in the drawing with respect to the terminal portion 32-3 and the driving force F2 from the drive electrode portion 51-7 on the upper right side in the drawing with respect to the terminal portion 32-3, and the relationship between the driving force F1 from the drive electrode portion 51-8 on the upper left side in the drawing with respect to the terminal portion 32-4 and the driving force F2 from the drive electrode portion 51-4 on the upper right side in the drawing with respect to the terminal portion 32-4.

Accordingly, the bias components are cancelled out in the terminal portions 32-1 to 32-4 and a drive component expressed by 2×FD1 is applied to the left in the X axis direction in the terminal portions 32-1 to 32-4 such that the main frames 30-1 and 30-2 are vibrated. As a result, the main frames 30-1 and 30-2 do not deform and vibration is stable which enables displacement of the transducer 20 to be accurately detected.

### Second Example Embodiment

In FIG. 3, a transducer 20-1 has long wide arm portions 21a and 21b extending to the outside in the X axis direction formed integrally on both ends in the Y axis direction. The arm portions 21a and 21b are connected at both ends in the X axis direction to both ends in the X axis direction of the main frames 30-1 and 30-2 via a pair of long narrow detecting beams 31a and 31b. The detecting beams 31a and 31b support the transducer 20-1 so that it is not easily displaced in the X axis direction but easily displaced in the Y axis direction with respect to the main frames 30-1 and 30-2. The detecting beams 31a and 31b are integrally formed with the arm portions 21a and 21b and the main frames 30-1 and 30-2 and extend in the X axis direction while floating above the substrate 10.

A transducer 20-2 also has arm portions 21c and 21d which are similar to the arm portions 21a and 21b described above. The arm portions 21c and 21d are connected to both ends in the X axis direction of the main frames 30-3 and 30-4 via detecting beams 31c and 31d which are similar to the detecting beams 31a and 31b described above. These detecting beams 31c and 31d also support the transducer 20-2 so that it is not easily displaced in the X axis direction but easily displaced in the Y axis direction with respect to the main frames 30-3 and 30-4.

The long wide sub-frames 32-1 and 32-2 are formed extending in the X axis direction floating above the substrate 10 to the outside in the Y axis direction of the main frame 30-1. The sub-frame 32-1 is connected via a plurality of long narrow driving beams 33a to the main frame 30-1, and connected via a plurality of long narrow driving beams 34a to a plurality of anchors 35a that are fixed to the substrate 10. The driving beams 33a and 34a are integrally formed with the main frame 30-1 and the sub-frame 32-1, extending in the Y axis direction and floating above the substrate 10. The driving beams 33a and 34a support the main frame 30-1 so that it is easily displaced in the X axis direction but not easily displaced in the Y axis direction with respect to the substrate 10.

Just as with the main frame 30-1, the sub-frames 32-2, 32-3, and 32-4 are provided on the outside in the Y axis direction of the main frames 30-2, 30-3, and 30-4, respectively. The main frames 30-2, 30-3, and 30-4 are also supported via the plurality of driving beams 33b to 33d, the sub-frames 32-2, 32-3, and 32-4, the plurality of driving beams 34b to 34d, and the plurality of anchors 35b to 35d in a manner easily displaceable in the X axis direction but not easily displaceable in the Y axis direction with respect to the substrate 10.

Also, the main frame 30-1 and the main frame 30-3 are connected together via a plurality of long narrow link beams 41a and 41c and a long wide link 42a. The link beams 41a and 41c are integrally formed with the main frames 30-1 and 30-3 and float above the substrate 10. One end of each of the link beams 41a is connected to the main frame 30-1 and one end of each of the link beams 41c connected to the main frame 30-3. The link beams 41a and 41c extend from there in the Y axis direction, with the other end of each of the link beams 41a and 41c connected to the link 42a. This link 42a is also integrally formed with the main frames 30-1 and 30-3 and extends in the X axis direction floating above the substrate 10.

Similar to the main frames 30-1 and 30-3, the main frame 30-2 and the main frame 30-4 are also connected together via a plurality of long narrow link beams 41b and 41d and a long wide link 42b.

The links 42a and 42b are connected together at each end by a plurality of long narrow sub-link beams 43a and 43b and a long wide sub-link 44a. The sub-link beams 43a and 43b are integrally formed with the links 42a and 42b and float above the substrate 10. One end of each of the sub-link beams 43a is connected to the link 42a and one end of each of the sub-link beams 43b connected to the link 42b. The sub-link beams 43a and 43b extend from there in the X axis direction, with the other end of each of the sub-link beams 43a and 43b connected to the sub-link 44a. This sub-link 44a is also integrally formed with the links 42a and 42b and extends in the Y axis direction floating above the substrate 10.

Also, on the substrate 10 are provided drive electrode portions 51-1 to 51-4 for driving the main frames 30-1 to 30-4 in the X axis direction with respect to the substrate 10, drive monitor electrode portions 52-1 to 52-4 for monitoring the driving of the main frames 30-1 to 30-4 in the X axis direction with respect to the substrate 10, detection electrode portions 53-1 to 53-4 for detecting vibration of the transducers 20-1 and 20-2 in the Y axis direction with respect to the substrate 10, adjustment electrode portions 54-1 to 54-4 for adjusting the resonance frequency in the Y axis direction of the transducers 20-1 and 20-2, and servo electrode portions 55-1 to 55-4 for suppressing vibration in the Y axis direction of the transducers 20-1 and 20-2.

The drive electrode portions 51-1, 51-2, 51-5, and 51-6 are integrally provided on both sides in the X axis direction of protruding portions 36a and 36b that extend floating above the substrate 10 on the outside in the Y axis direction at the end portions on the outside in the X axis direction of the main frames 30-1 and 30-2. These drive electrode portions 51-1, 51-2, 51-5, and 51-6 each include pectinate (i.e., comblike) movable electrode fingers 51a1, 51a2, 51a5, and 51a6 formed extending in the X axis direction, and pectinate fixed electrode fingers 51b1, 51b2, 51b5, and 51b6 also formed extending in the X axis direction.

The movable electrode fingers 51a1, 51a2, 51a5, and 51a6 are integrally formed extending from both sides in the X axis direction of the protruding portions 36a and 36b and floating above the substrate 10. These movable electrode fingers 51a1, 51a2, 51a5, and 51a6 fit in between adjacent fixed electrode fingers 51b1, 51b2, 51b5, and 51b6 which also extend in the X axis direction in an opposing manner. The fixed electrode fingers 51b1, 51b2, 51b5, and 51b6 are connected, via wiring portions 51c1, 51c2, 51c5, and 51c6 that are integrally fixed on the substrate 10, to pad portions 51d1, 51d2, 51d5, and 51d6 that are integrally fixed on the substrate 10. Electrode pads 51e1, 51e2, 51e5, and 51e6 formed of a conductive metal (such as aluminum) are provided on the top surface of the pad portions 51d1, 51d2, 51d5, and 51d6.

The drive electrode portions 51-3, 51-4, 51-7, and 51-8 are integrally provided on both sides in the X axis direction of the protruding portions 36c and 36d which extend floating above the substrate 10 on the outside in the Y axis direction at the end portions on the outside in the X axis direction of the main frames 30-3 and 30-4. These drive electrode portions 51-3, 51-4, 51-7, and 51-8 each include pectinate (i.e., comblike) movable electrode fingers 51a3, 51a4, 51a7, and 51a8 formed extending in the X axis direction, and pectinate fixed electrode fingers 51b3, 51b4, 51b7, and 51b8 formed extending in the X axis direction.

The movable electrode fingers 51a3, 51a4, 51a7, and 51a8 are integrally formed extending from both sides in the X axis direction of the protruding portions 36c and 36d and floating above the substrate 10. These movable electrode fingers 51a3, 51a4, 51a7, and 51a8 fit in between adjacent fixed electrode fingers 51b3, 51b4, 51b7, and 51b8 which also extend in the X axis direction in an opposing manner. The fixed electrode fingers 51b3, 51b4, 51b7, and 51b8 are connected, via wiring portions 51c3, 51c4, 51c7, and 51c8 that are integrally fixed on the substrate 10, to pad portions 51d3, 51d4, 51d7, and 51d8 that are integrally fixed on the substrate 10. Electrode pads 51e3, 51e4, 51e7, and 51e8 formed of a conductive metal (such as aluminum) are provided on the top surface of the pad portions 51d3, 51d4, 51d7, and 51d8.

The drive monitor electrode portions 52-1 to 52-4 are provided on the inside or outside in the X axis direction of the protruding portions 36a, 36b, 36c, and 36d (FIG. 3 shows them provided on the outside in the X axis direction). These drive monitor electrode portions 52-1 to 52-4 each include pectinate (i.e., comblike) movable electrode fingers 52a1, 52a2, 52a3, and 52a4 formed extending in the X axis direction, and pectinate fixed electrode fingers 52b1, 52b2, 52b3, and 52b4 also formed extending in the X axis direction.

The movable electrode fingers 52a1, 52a2, 52a3, and 52a4 are integrally formed extending from the outside in the X axis direction of the protruding portions 36a, 36b, 36c, and 36d and floating above the substrate 10. These movable electrode fingers 52a1, 52a2, 52a3, and 52a4 fit in between adjacent fixed electrode fingers 52b1, 52b2, 52b3, and 52b4 which also extend in the X axis direction in an opposing manner. The fixed electrode fingers 52b1, 52b2, 52b3, and 52b4 are connected, via wiring portions 52c1, 52c2, 52c3, and 52c4 that are integrally fixed on the substrate 10, to pad portions 52d1, 52d2, 52d3, and 52d4 that are integrally fixed on the substrate 10. Electrode pads 52e1, 52e2, 52e3, and 52e4 formed of a conductive metal (such as aluminum) are provided on the top surface of the pad portions 52d1, 52d2, 52d3, and 52d4.

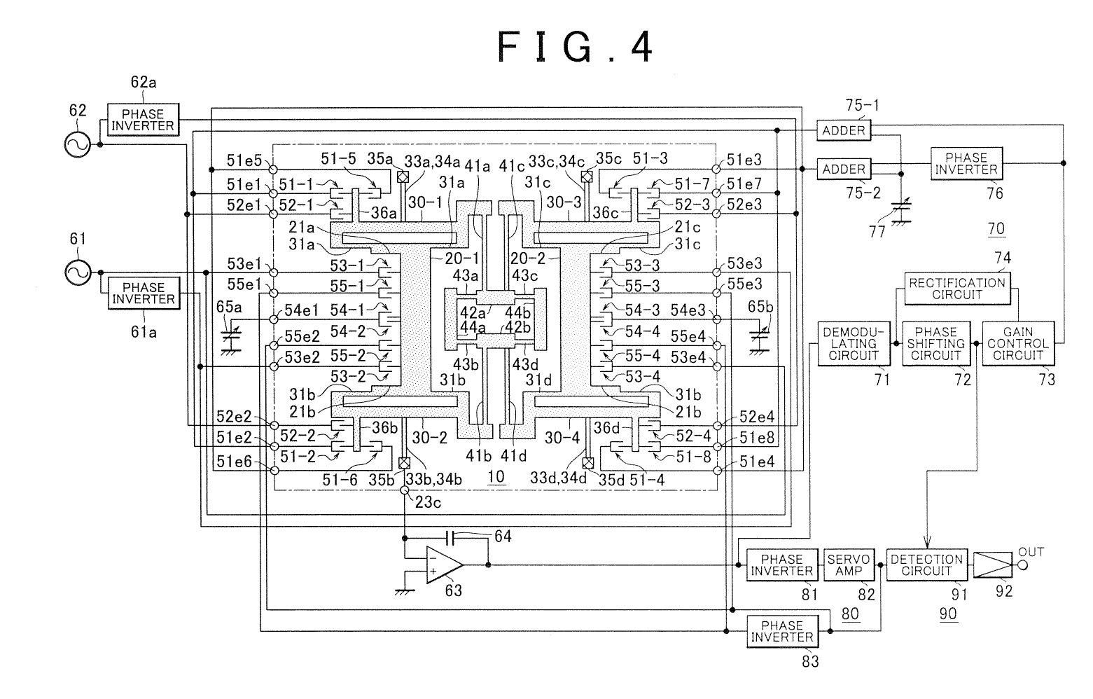

Next, an electrical circuit device for detecting angular velocity using an angular velocity detecting element having a structure like that described above will be described. FIG. 4 is a block diagram of the electrical circuit device.

A drive circuit 70 is connected to each electrode pad 51e1 to 51e8 of the drive electrode portion 51-1 to 51-8. This drive circuit 70 generates a drive signal based on a signal input from an electrode pad 23c via a charge amplifier 63 and then supplies that drive signal to each of the electrode pads 51e1 to 51e8.

Here, in order to simplify the description, a signal output by a gain control circuit 73 will be defined as VD sin(ωt), and a direct current voltage signal (i.e., a bias voltage signal) output by a variable voltage supply circuit 77 will be defined as VB.

An adder 75-1 adds the signal VD sin(ωt) from the gain control circuit 73 to the direct current voltage signal VB from the variable voltage supply circuit 77 and supplies the sum voltage [VB+VD sin(ωt)] to the electrode pads 51e1, 51e2, 51e7, and 51e8 of the drive electrode portions 51-1, 51-2, 51-7, and 51-8. An adder 75-2 adds a signal −VD sin(ωt) from a phase inverter 76 to the direct current voltage signal VB from the variable voltage supply circuit 77 and supplies the sum voltage [VB−VD sin(ωt)] to the electrode pads 51e3, 51e4, 51e5, and 51e6 of the drive electrode portions 51-3, 51-4, 51-5, and 51-6.

If the driving force from the drive electrode portions 51-1, 51-2, 51-7, and 51-8 to which the sum voltage [VB+VD sin(ωt)] is supplied by the adder 75-1 is designated F1 and the driving force from the drive electrode portions 51-3, 51-4, 51-5, and 51-6 to which the sum voltage [VB−VD sin(ωt)] is supplied by the adder 75-2 is designated F2, then relational expressions like in Expressions 1 to 7 above are satisfied, similar to the first example embodiment.

The magnitude of force of the bias component FB1 of the driving force F1 from the drive electrode portion 51-1 on the upper left side in the drawing with respect to the protruding portion 36a is the same as that of the bias component FB2 of the driving force F2 from the drive electrode portion 51-5 on the upper right side in the drawing with respect to the protruding portion 36a, but the directions of those forces are the opposite. As a result, they cancel each other out in the protruding portion 36a. Also, the drive component FD1 of the driving force F1 from the drive electrode portion 51-1 is generated to the left in the X axis direction, and the drive component FD2(=−FD1) of the driving force F2 from the drive electrode 51-5 is generated to the right in the X axis direction. As a result, FD1−(−FD1)=2×FD1 is generated to the left in the X axis direction in the protruding portion 36a. The same can also be said for the relationship between the driving force F1 from the drive electrode portion 51-2 on the upper left side in the drawing with respect to the protruding portion 36b and the driving force F2 from the drive electrode portion 51-6 on the upper right side in the drawing with respect to the protruding portion 36b, the relationship between the driving force F1 from the drive electrode portion 51-3 on the upper left side in the drawing with respect to the protruding portion 36c and the driving force F2 from the drive electrode portion 51-7 on the upper right side in the drawing with respect to the protruding portion 36c, and the relationship between the driving force F1 from the drive electrode portion 51-4 on the upper left side in the drawing with respect to the protruding portion 36d and the driving force F2 from the drive electrode portion 51-8 on the upper right side in the drawing with respect to the protruding portion 36d.

Accordingly, the bias components are cancelled out in the protruding portions 36a to 36d and a drive component expressed by 2×FD1 is applied to the left in the X axis direction in the protruding portions 36a to 36d such that the main frames 30-1 to 30-4 are vibrated. As a result, the main frames 30-1 to 30-4 vibrate stably around the protruding portions 36a to 36d such that displacement of the transducers 20-1 and 20-2 can be accurately detected.

While example embodiments of the invention have been described in detail, the invention is not limited to these example embodiments. To the contrary, various modifications are also possible within the scope of the invention.

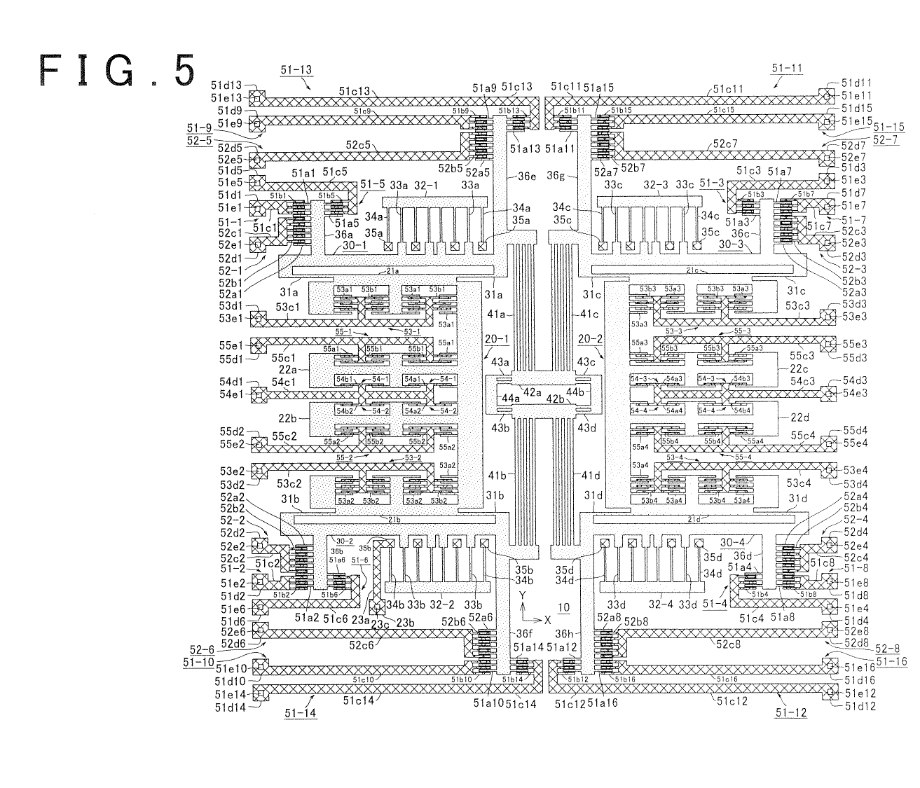

For example, when a drive electrode portion for increasing the driving force F is added in the second example embodiment, drive electrode portions 51-9 to 51-16 need only be integrally provided on both sides in the X axis direction of protruding portions 36e to 36h which extend floating above the substrate 10 on the outside in the Y axis direction at the end portion on the inside in the X axis direction of the main frames 30-1 to 30-4, as shown in FIG. 5. Also, drive monitor electrode portions 52-5 to 52-8 need only be provided on the inside or outside in the X axis direction of the protruding portions 36a, 36b, 36c, and 36d (FIG. 5 shows a case in which they are provided on the outside in the X axis direction). In order to increase the driving force F, the bias voltage VB may be increased, though this tends to result in leakage between adjacent wires and so is an effective method when there is enough space to increase the drive electrode portions on the substrate 10.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

What is claimed is:

1. A mechanical quantity detecting element comprising:
a substrate;
a frame displaceably supported in a first direction that is parallel to a surface of the substrate;
a transducer displaceably supported, with respect to the frame, in a second direction that is perpendicular to the first direction and parallel to the surface of the substrate; and
a plurality of drive electrode portions which are provided on the frame and drive the frame in the first direction, wherein:
the frame includes a terminal portion where an end of the frame extends in the second direction; and
at least one of the plurality of drive electrode portions is arranged on each side of the terminal portion in the first direction.

2. The mechanical quantity detecting element according to claim 1 wherein a drive monitor portion which monitors the driving of the frame in the first direction with respect to the substrate is arranged on one side of the terminal portion in the first direction.

3. The mechanical quantity detecting element according to claim 1, wherein the transducer is connected to the frame via a beam.

4. The mechanical quantity detecting element according to claim wherein the transducer and the frame are provided separated by a predetermined distance from the substrate via a beam that is fixed to the substrate.

5. A mechanical quantity detecting device provided with the mechanical quantity detecting element according to claim 1, wherein displacement of the transducer in the second direction is detected while the frame is vibrated in the first direction with respect to the substrate in response to a drive signal having a predetermined phase being input to the at least one of the plurality of a drive electrode portions provided on one side of the terminal portion in the first direction, and a drive signal in which the phase is reversed with respect to the predetermined phase being input to the at least one of the plurality of drive electrode portions provided on the other side of the terminal portion in the first direction.

6. The mechanical quantity detecting device according to claim 5, wherein:
the drive signals include a bias voltage and a driving voltage;
the bias voltage and the driving voltage are input to the at least one of the plurality of the driving electrode portions provided on one side in the first direction of the terminal portion; and
the bias voltage, the driving voltage, and a reversed-phase driving voltage are input to the at least one of the plurality of drive electrode portions provided on the other side of the terminal portion in the first direction.
